(19) United States
(12) Patent Application Publication
(10) Pub. No.: US 2015/0361249 A1
(43) Pub. Date: Dec. 17, 2015

(54) BARRIER STRUCTURE

(71) Applicants: Ta-Jo LIU, Taipei (TW); Chih-kuang YANG, Hsinchu (TW)

(72) Inventors: Ta-Jo LIU, Taipei (TW); Chih-kuang YANG, Hsinchu (TW)

(21) Appl. No.: 14/761,953

(22) PCT Filed: Jan. 18, 2013
(86) PCT No.: PCT/CN2013/070657

§ 371 Date: Jul. 20, 2015

(51) Int. Cl. C08K 5/56; B32B 27/06

(52) U.S. Cl. CPC C08K 5/56; B32B 27/06; B32B 2307/7244; B32B 2307/7246; B32B 2439/70; B32B 2457/00; B32B 2255/24

(57) ABSTRACT

A barrier structure is disclosed. The barrier structure is utilized for covering at least a part of an object for protecting the object from gas and water in an external environment and includes a solid layer and a liquid layer. The solid layer has a first surface and a second surface. The first surface directly contacts the external environment. The solid layer is penetrable by at least one type of gas. The liquid layer contacts the second surface. An interface is formed between the second surface of the solid layer and the liquid layer. The barrier structure has ductility, flexibility, and bendability to cover the object, protect the object from the external environment, and provide the required barrier characteristic against the water or the gas.

### BACKGROUND OF THE INVENTION

1. Field of the Invention

The present invention generally relates to a barrier structure, and more particularly to a barrier structure capable of maintaining barrier characteristic with long period performance and high barrier performance against an external environment.

2. Description of Prior Art

Science and technology are progressing with each passing day. Various types of consuming electronic products are published in succession. Many product manufacturers hope to bring innovation which is more attractive and complies with humanity for attracting consumers. Many manufacturers are actively involved in manufacturing micro-electromechanical products, especially research and development of flexible electronic technology, e.g. flexible and bendable plastic material or a thin metal substrate. Furthermore, since electro-optical products are flourishing recently, organic light emitting diodes (OLEDs), flexible liquid crystal display (LCD) or light emitting diode (LED) displays, electronic papers, thin film photovoltaic cells, and organic photovoltaic cells are flexible electronic products with unlimited potential in the future.

However, microminiaturization and thinning tendency of corresponding components in an electronic product is inevitable direction in the current science and technology field. A largest factor which affects life spans of many key components is how to effectively maintain barrier characteristic of the key components against the external environment during the lifespan of the electronic product when the electronic product is microminiaturized and thinned.

The barrier characteristic of a plastic material is worse than that of a glass. When the plastic material or the thin metal material is substituted for the conventional glass, a solution to a problem which the manufacturers have to face with is to improve the barrier characteristic against the external environment, especially water and gas (especially oxygen).

Moreover, for foods, medicines, or other objects, the barrier characteristic with the long period performance is required to be maintained against the external environment. For example, the oxygen is a main reactant which causes food corruption. Moisture intrusion (or loss) is a main factor which changes food flavor.

To solve the above-mentioned problem, a gas barrier film is a common and widely utilized solution scheme, such that the components in the electronic products, the foods, the medicines, or other objects in which the barrier characteristic is required to be maintained are protected from contacting the external environment, especially the water or the gas (especially the oxygen). The prior art adopts plural thin films and selection of material with a gas barrier function as a direction and a goal of technical development. It is noted that the solution schemes in the prior art are implemented in a solid state multi-layer deposited film regardless of manufacturing methods or materials. Films of the most commonly utilized materials, such as inorganic materials, do not have flexibility and bendability which are suitable for the conventional technology, and thus they can only be limited to be developed for specific products and objects. The films is basically limited and cannot adaptively and effectively protect components in electronic products, foods, medicines, or other objects in which the barrier characteristic should exist against the external environment.

### SUMMARY OF THE INVENTION

An object of the present invention is to provide a barrier structure which can cover at least a part of an object for protecting the object from gas and water in an external environment.

Another object of the present invention is to provide a barrier structure which has ductility, flexibility, and bendability to cover an object with any shape or appearance, protect the object from the external environment, and provide the required barrier characteristic against the water or the gas (especially oxygen).

The barrier structure of the present invention is utilized for covering at least a part of an object for protecting the object from gas and water in an external environment and comprises a first condensed matter layer and a second condensed matter layer. The first condensed matter layer has a first surface and a second surface. The first surface directly contacts the external environment. The first condensed matter layer is penetrable by at least one type of gas. The second condensed matter layer contacts the second surface. An interface is formed between the second surface of the first condensed matter layer and the second condensed matter layer.

In an embodiment of the present invention, the first condensed matter layer is a material with static pores. The static pores may be intermolecular free volume (free volume) or structural defects. The second condensed matter layer fills a part of the static pores of the first condensed matter layer. The second condensed matter layer may be a material without static pores, for example, a liquid material which has only dynamic free volume but does not have the structural defects which a solid material has. The static pores in the first condensed matter layer are formed in paths for the water or the gas in the external environment. The paths in the interface between the first condensed matter layer and the second condensed matter layer are non-pore interfaces for protecting the object from the water or the gas in the external environment.

Furthermore, in an embodiment of the present invention, the first condensed matter layer may be a flexible solid layer or a bendable solid layer. The second condensed matter layer may be a liquid material or a glue material. The first condensed matter layer may also be a polymer.

Furthermore, the barrier structure of the present invention further comprises a substrate layer and a bonding material on a surface opposite to a surface of the second condensed matter layer contacting the second surface of the first condensed matter layer. The substrate layer has a predetermined border. The first condensed matter layer and the substrate layer are bonded on the predetermined border by the bonding material to keep the second condensed matter layer between the first condensed matter layer and the substrate layer. The substrate layer may be a glass or a metal material. Alternatively, the substrate layer may be a polymer. Alternatively, the first condensed matter layer, the bonding material, and the substrate layer may be formed of organic material. The first condensed matter layer, the bonding material, and the substrate layer are bonded by a heat-pressing method. Alternatively, the first condensed matter layer and the substrate layer may be formed of organic material. The first condensed matter layer and the substrate layer are bonded on the predetermined border by a heat-pressing method to keep the second condensed matter layer between the first condensed matter layer and the substrate layer.

In an embodiment of the present invention, the first condensed matter layer has an internal space and has at least one opening.

Furthermore, in an embodiment of the present invention, the second condensed matter layer further comprises plural polar molecules. The polar molecules comprise hydrogen bond molecules, coordinating functional group molecules, or charged ions. Furthermore, the second condensed matter layer comprises at least one type of chemical molecules. The chemical molecules comprise a specific functional group for forming a hydrogen bond or forming a polar molecule action with water molecules in the water. Alternatively, the specific functional group included in the chemical molecules may be utilized with oxygen molecules in the oxygen for forming a coordination complex or utilized with carbon dioxide molecules in the external environment for forming a coordination complex. The barrier structure of the present invention has different transmittances for at least two types of gas molecules.

### DETAILED DESCRIPTION OF THE INVENTION

The present invention provides a barrier structure for covering at least a part of an object for protecting the object from gas and water in an external environment. The barrier structure comprises a first condensed matter layer, which has a first surface and a second surface, and a second condensed matter layer contacting the second surface. The first surface directly contacts the external environment. The first condensed matter layer is penetrable by at least one type of gas. An interface is formed between the second surface of the first condensed matter layer and the second condensed matter layer for protecting the object from the water and the gas in the external environment. The barrier structure can be applied to a component in an electronic product, food, medicine, or the object in which barrier characteristic is required against the external environment. The electronic product may be an organic light emitting diode, a flexible liquid crystal display, an electronic paper, an organic solar cell, or a thin-film solar cell but not limited thereto.

The barrier structure provided by the present invention at least comprises the first condensed matter layer and the second condensed matter layer. The interface formed between the first condensed matter layer and the second matter protects the covered object from contacting the water or the gas in the external environment.

The first condensed matter layer may be a flexible or a bendable solid layer, and a material thereof may be an organic material or a polymer, for example, PE, PET, PP, PVC and so on. Alternatively, the first condensed matter layer may be a polymer. The second condensed matter layer may be formed of a material without static pores. The present invention is constructed by the first condensed matter layer and the second condensed matter layer. The first condensed matter layer is a material with static pores. The static pores may be intermolecular free volume (free volume) or structural defects. When the interface is formed, the second condensed matter layer can fill a part of the static pores of the first condensed matter layer close to the interface, such that the interface has a high barrier performance.

Moreover, the present invention may further comprise a substrate layer and a bonding material on a surface opposite to a surface of the second condensed matter layer contacting the second surface of the first condensed matter layer. The substrate layer has a predetermined border. For example, when the barrier structure of the present invention is formed as a rectangular shape, the predetermined border is a rectangular shape. However, the predetermined shape in the present invention is not limited. The first condensed matter layer and the substrate layer are bonded on the predetermined border by the bonding material, such that the second condensed matter layer is kept between the first condensed matter layer and the substrate layer. Furthermore, the second condensed matter layer may be formed on the substrate layer or the first condensed matter layer but is not limited thereto. The second condensed matter layer can depend on a practical situation. The substrate layer may be a glass, a metal foil, or a polymer.

Moreover, the substrate layer and the first condensed matter layer of the present invention may be formed of organic material. As mentioned above, the substrate layer has the predetermined border, and the predetermined border, for example, is a rectangular shape. However, the shape of the substrate layer of the present invention is not limited. The first condensed matter layer and the substrate layer may be directly bonded together on the predetermined border with a heat pressing method, such that the second condensed matter layer is kept between the first condensed matter layer and the substrate layer without the above-mentioned bonding material.

Moreover, the first condensed matter layer of the present invention may have an internal space and at least one opening. For example, the first condensed matter layer is directly formed as a rectangular object which has a predetermined rectangular border and comprises a top first condensed matter layer and a bottom first condensed matter layer. For example, an opening is formed on the predetermined border. Then, the second condensed matter layer is placed in the internal space (i.e. between the top condensed matter layer and the bottom condensed matter layer) via the opening, and the opening is sealed to implement the barrier structure of the present invention.

Moreover, the first condensed matter layer, the second condensed matter layer, and the substrate layer are not limited to a single layer. The first condensed matter layer, the second condensed matter layer, and the substrate layer may be manufactured by alternately stacking plural layers. Alternatively, the first condensed matter layer, the second condensed matter layer, and the substrate layer may be repeatedly and alternately stacked in sequence or made of different layers. According to the present invention, at least one interface can effectively protect the object from the water or the gas in the external environment.

As mentioned above, the first condensed matter layer may be formed of organic material, a polymer, or a solid phase object. For example, the static pores in the first condensed matter layer are pores which are internally formed when long molecular chains twine with each other. Paths for forming the pores may be penetrated by the water or the gas (especially oxygen) in the external environment. The static pores may be intermolecular free volume (free volume) or structural defects. That is, the static pores in the first condensed matter layer are formed in possible paths for the water or the gas in the external environment. However, the static pores do not exist in the above-mentioned second condensed matter layer which is formed of a liquid material or a glue material. The liquid material has only dynamic free volume, but the liquid material does not have the structural defects which a solid material has. Accordingly, the interface of the pores do not exist in the interface between the first condensed matter layer and the second condensed matter layer. When the water or the gas (especially oxygen) in the external environment tends to penetrate the second condensed matter layer, the water or the gas (especially oxygen) is required to be absorbed by the second condensed matter layer and diffused in the second condensed matter layer firstly. Then, the water or the gas (especially oxygen) contacts the object after separating from the interface between the second condensed matter layer and the substrate layer or overlapping layers. Although the mechanism for penetrating the second condensed matter layer is similar to the mechanism for penetrating first condensed matter layer, the penetration barrier of the second condensed matter layer is larger. As a result, it is almost impossible to penetrate the second condensed matter layer.

Moreover, according to the present invention, the second condensed matter layer is formed of a non-solid material or a continuous phase material, for example, a liquid material or a glue material. Consequently, the second condensed matter layer can fill a part of the static pores in the first condensed matter layer close to the interface. When the water or the gas (especially oxygen) in the external environment penetrates the paths of the static pores in the first condensed matter layer, a high concentration gradient is formed at the barrier interface and thus it is disadvantageous that the required diffusion phenomenon occurs when the water or the gas tends to penetrate the second condensed matter layer. Accordingly, it is more difficult for the water or the gas in the external environment to penetrate the second condensed matter layer.

Moreover, in an embodiment of the present invention, the second condensed matter layer may comprise a plurality of polar molecules. The polar molecules may comprise hydrogen-bonding molecules, molecules with chelating group, or charged ions. Accordingly, the barrier characteristic may be enhanced. There is a strong force between gas molecules and liquid molecules, such that the water or the gas (especially oxygen) is absorbed to the barrier interface between the first condensed matter layer and the second condensed matter layer. The absorbed water or gas (especially gas) is not easily separated from the interface due to the above-mentioned strong force. Accordingly, it is disadvantageous for the water or the gas (especially oxygen) to be diffused or absorbed by the second condensed matter layer. That is, the diffusion phenomenon can be significantly reduced. The polar molecules in the above-mentioned embodiment of the present invention can further enhance the barrier characteristic of the barrier structure of the present invention.

In an embodiment of the present invention, the first condensed matter layer and the second condensed matter layer may be formed of the same material or different materials. The first condensed matter layer and the second condensed matter layer may be polyethylene terephthalate (PET) material, polyethylene naphthalate (PEN) material, polyethersulfone material, polyimide material, polycarbonate material, cyclic olefin polymer, platinum foil, or elastic glass. Since the cost of the polyethylene terephthalate (PET) material and the polyethylene naphthalate (PEN) material are cheap, the polyethylene terephthalate (PET) material and the polyethylene naphthalate (PEN) material are the most commonly utilized for flexible electrical products due to the advantage of the low cost. Furthermore, the first condensed matter layer, the second condensed matter layer, and the substrate layer may be formed of transparent material with high transmittance, so as to be applied to optical electrical products. For example, the transmittance is greater than 80%-90%.

Moreover, the first condensed matter layer and the substrate layer may be sealed or heat pressed by utilizing UV (ultraviolet) curing resin, thermosetting resin, or solid bonding material, such that the second condensed matter layer is kept between the first condensed matter layer and the substrate layer.

In an embodiment of the present invention, the second condensed matter layer may be volatile liquid, non-volatile liquid, or flowable glue. For example, a viscosity of the layer without the static pores is ranged from 1 mPa·s to 1000 mPa·s, and a thickness of the layer is ranged from 20 μm to 100 μm. Furthermore, when the second condensed matter layer is formed of the non-volatile liquid, it can be selected from a group consisting of lubricating oil, silicon oil, glycerin, ionic liquid, inedible soybean oil, non-volatile organic alcohol, or combinations thereof. When the second condensed matter layer is formed of the volatile liquid or the flowable glue, the second condensed may be any material compatible with the first condensed matter layer and the substrate layer. The present invention is not limited to the above-mentioned embodiment.

In an embodiment of the present invention, the first condensed matter layer may be thermosetting resin or UV curing resin. Compared to the thermosetting resin, the UV curing resin can crosslink completely in a curing process, thereby avoiding the leakage of the second condensed matter layer due to a defect which occurs when a solvent is volatilized in a drying process. Therefore, the UV curing resin is a preferred choice, but the present invention is not limited to the UV curing resin.

In the barrier structure comprising the substrate layer according to an embodiment of the present invention, the second condensed matter layer may be coated on the substrate layer firstly. Then, the first condensed layer, for example, UV curing resin or thermosetting resin, is coated on the second condensed matter layer. After the resin is hardened, the second condensed matter layer is sealed between the first condensed matter layer and the substrate layer. The UV curing resin or the thermosetting resin is utilized as an adhesion layer, such that the second condensed matter layer is covered between the first condensed matter layer and the substrate layer by a physical absorbing and adhesion method. The UV curing resin may be selected from a group consisting of acrylic glue, epoxy resin, polyimide, polyester, polyurethane, silicone gel, or combinations thereof.

As mentioned above, the first condensed matter layer, the second condensed matter layer, and the substrate layer of the present invention are not limited to a single layer. In an embodiment of plural layers which are alternately stacked, the barrier structure of the present invention may further comprise a cladding layer disposed on an outermost surface of the barrier structure contacting the external environment. The cladding layer, for example, may be an inorganic nano-dispersion and may be a nano-oxide silicon dispersion, a nano-titanium dioxide dispersion, a nano-nickel dispersion, a nano-silver dispersion, a carbon nanotube dispersion, or a nano-clay dispersion for further improving the barrier effect of the present invention. For example, the nano-oxide silicon dispersion has good thermal and gas barrier properties, and a coefficient of thermal expansion (CTE) is 3×10⁻⁸ m/° C. However, the present invention is not limited to the nano-oxide silicon dispersion.

In an embodiment of the present invention, the provided barrier structure at least comprises a solid layer and a liquid layer. The solid layer has a first surface and a second surface. The first surface directly contacts the external environment. The solid layer is penetrable by at least one type of gas. An interface is formed between the second surface of the solid layer and the liquid layer. In the embodiment of the present invention, the solid layer may be a polymer. The solid layer is a flexible or a bendable solid. In the embodiment of the present invention, the liquid layer comprises at least one type of chemical molecules. The chemical molecules comprise a specific functional group for forming a hydrogen bond or forming a polar molecule action with water molecules in the water. Furthermore, the chemical molecules may further comprise a specific functional group for coordinating with oxygen molecules in the oxygen. The following diagram is an example of a coordination complex for coordinating with the oxygen molecules (taking Heme for example):

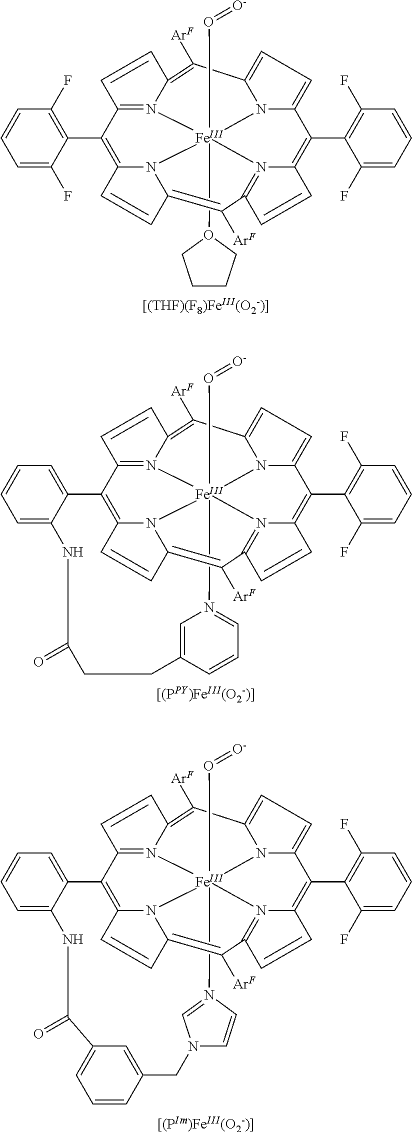

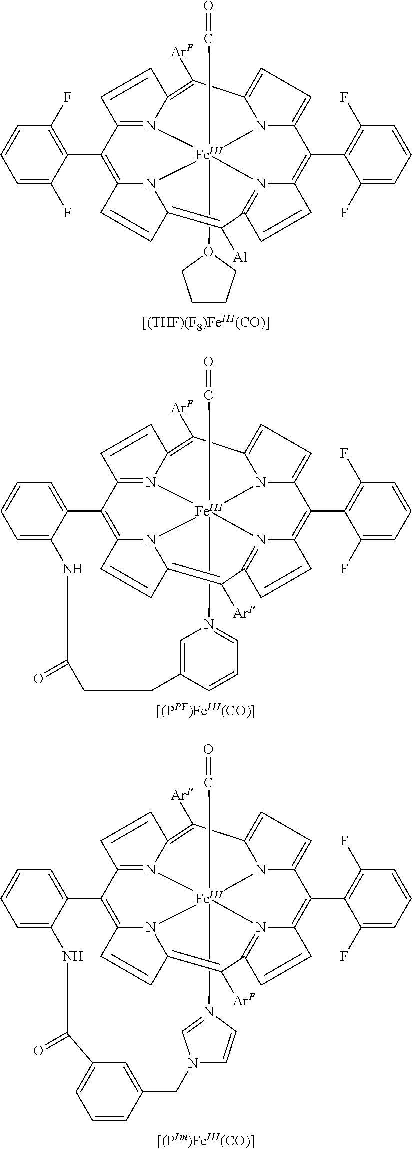

The following diagram is another example of a coordination complex for coordinating with the oxygen molecules:

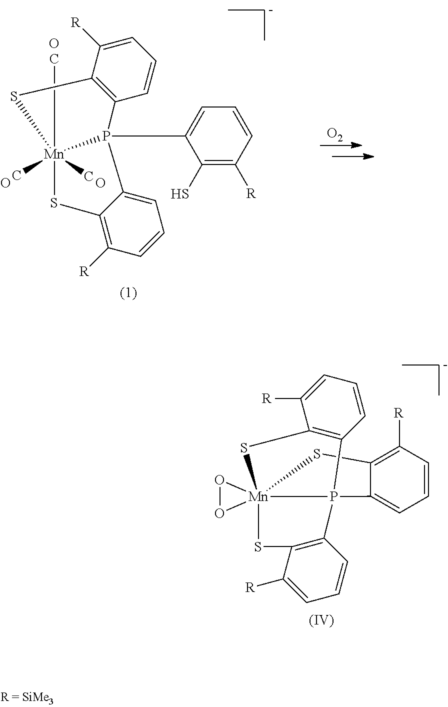

Alternatively, a coordination complex is formed of carbon dioxide molecules in the external environment:

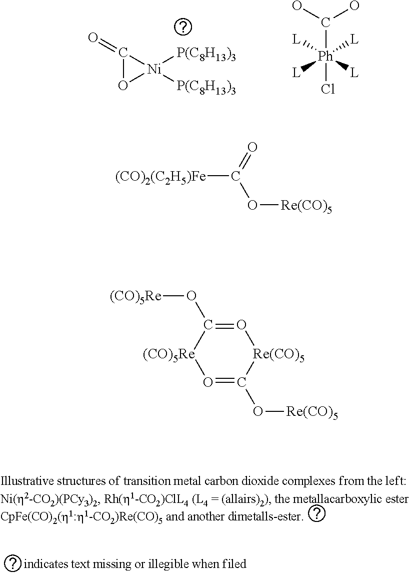

Moreover, the liquid layer may further comprise plural polar molecules. The polar molecules comprise hydrogen bond molecules, coordinating functional group molecules, or charged ions. There is a strong force between gas molecules and liquid molecules. The specific functional group, for example, may be —OH, —O—, ↑CO, —F, —NH2, —N═N, and so on. The water or the gas (especially oxygen) is absorbed to the liquid layer. The above-mentioned strong force decreases a diffusion coefficient and further decreases and controls a transmittance of the gas molecules. It can be appreciated from the above-mentioned formation technology that the present invention can control the formulation to control the transmittances of different gas molecules. Accordingly, in the embodiment of the present invention, the barrier structure has different transmittances for at least two types of gas molecules.

A method for manufacturing the barrier structure provided by the present invention may be implemented by a wet coating method. In the present invention, the barrier interface formed between the first condensed matter layer and the second condensed matter layer is utilized for protecting the object from the water or the gas in the external environment. As a result, the manufacturing process is not limited to a totally wet coating process. Alternatively, the totally wet coating process is utilized together with an adhesive process. That is, the second condensed matter layer is formed on the substrate layer or the first condensed layer by the wet coating process, and then the following process or similar process is implemented. Furthermore, the above-mentioned wet coating process may be a bar coating process, a blade coating process, a roller coating process, a dip coating process, a spin coating process, a slot die coating process, a curtain coating process, or a slide coating process. The barrier structure can be manufactured via a patch-by-patch process or a roll-to-roll process.

In summary, the second condensed matter layer of the present invention is coated on the substrate layer or the first condensed matter layer by utilizing the wet coating process. The barrier structure may be mass produced because the low cost of the wet coating process. In the meantime, a drying process which is required in the prior art because each layer is solid can be omitted in the present invention, such that a problem that apparent or latent defects exist in each layer in the prior art due to the drying process can be avoided. In contrast, forming only at least one interface in the present invention can protect the object from the water or the gas in the external environment, thereby implementing the object of the present invention. Compared with the prior art, the present invention is not limited to be developed for specific products and objects, and thus the manufacturing cost can be significantly decreased. The barrier structure of the present invention has ductility, flexibility, and bendability to cover an object with any shape or appearance, protect the object from the external environment, and provide the required barrier characteristic against the water or the gas (especially oxygen). As a result, the present invention can adaptively and effectively protect components in electronic products, foods, medicines, or other objects in which the barrier characteristic should exist against the external environment. The present invention can be applied to various aspects.

As is understood by a person skilled in the art, the foregoing preferred embodiments of the present invention are illustrative rather than limiting of the present invention. It is intended that various modifications and similar arrangements are to be included within the spirit and scope of the appended claims, the scope of which should be accorded the broadest interpretation so as to encompass all such modifications and similar structures.

What is claimed is:

1. A barrier structure, characterized in covering at least a part of an object for protecting the object from gas and water in an external environment and comprising:
a solid layer having a first surface and a second surface, the first surface directly contacting the external environment, and the solid layer being penetrable by at least one type of gas; and
a liquid layer contacting the second surface, and an interface being formed between the second surface of the solid layer and the liquid layer.

2. The barrier structure of claim 1, characterized in that the solid layer is a polymer.

3. The barrier structure of claim 1, characterized in that the solid layer is a flexible solid.

4. The barrier structure of claim 1, characterized in that the solid layer is a bendable solid.

5. The barrier structure of claim 1, characterized in further comprising a substrate layer and a bonding material on a surface opposite to a surface of the liquid layer contacting the second surface of the solid layer, the substrate layer having a predetermined border, and the solid layer and the substrate layer being bonded on the predetermined border by the bonding material to keep the liquid layer between the solid layer and the substrate layer.

6. The barrier structure of claim 5, characterized in that the substrate layer is a glass or a metal material.

7. The barrier structure of claim 5, characterized in that the substrate layer is a polymer.

8. The barrier structure of claim 5, characterized in that the solid layer, the bonding material, and the substrate layer are formed of organic material.

9. The barrier structure of claim 8, characterized in that the solid layer, the bonding material, and the substrate layer are bonded by a heat-pressing method.

10. The barrier structure of claim 1, characterized in further comprising a substrate layer on a surface opposite to a surface of the liquid layer contacting the second surface of the solid layer, and the solid layer and the substrate layer being formed of organic material.

11. The barrier structure of claim 10, characterized in that the substrate layer has a predetermined border, and the solid layer and the substrate layer are bonded on the predetermined border by a heat-pressing method.

12. The barrier structure of claim 1, characterized in that the solid layer has an internal space and has at least one opening.

13. The barrier structure of claim 12, characterized in that the liquid layer is placed in the internal space via the at least one opening for forming the interface.

14. The barrier structure of claim 1, characterized in that the liquid layer comprises at least one type of chemical molecules, and the chemical molecules comprise a specific functional group for forming a hydrogen bond with water molecules in the water.

15. The barrier structure of claim 1, characterized in that the liquid layer comprises at least one type of chemical molecules, and the chemical molecules comprise a specific functional group for forming a polar molecule action with water molecules in the water.

16. The barrier structure of claim 1, characterized in that the liquid layer comprises at least one type of chemical molecules, the chemical molecules comprise a specific functional group, and the specific functional group is utilized with oxygen molecules in oxygen for forming a coordination complex.

17. The barrier structure of claim 1, characterized in that the liquid layer comprises at least one type of chemical molecules, the chemical molecules comprise a specific functional group, and the specific functional group is utilized with carbon dioxide molecules in the external environment for forming a coordination complex.

18. The barrier structure of claim 1, characterized in that the liquid layer comprises a plurality of polar molecules.

19. The barrier structure of claim 18, characterized in that the polar molecules comprise hydrogen-bonding molecules, molecules with chelating group, or charged ions.

20. The barrier structure of claim 1, characterized in that the barrier structure has different transmittances for at least two types of gas molecules.
